(19) United States
(12) Patent Application Publication
(10) Pub. No.: US 2015/0032412 A1
(43) Pub. Date: Jan. 29, 2015

(54) LOW POWER MOVEMENT SENSOR

(71) Applicant: ICU SENSOR LLC, RIVER EDGE, NJ (US)

(72) Inventors: SERGEY CHIZHEVSKIY, VAUGHAN (CA); EREZ ROTEM, FAIR LAWN, NJ (US); ERAN BASIS, RIVER EDGE, NJ (US); YEHIEL LIPKA, KIRYAT ONO (IL)

(21) Appl. No.: 14/339,503

(22) Filed: Jul. 24, 2014

Related U.S. Application Data
(60) Provisional application No. 61/858,127, filed on Jul. 25, 2013.

(51) Int. Cl. G01B 21/16; G01B 17/00; G01B 11/14

(52) U.S. Cl. CPC G01B 21/16; G01B 11/14; G01B 17/00
USPC 702/158

(57) ABSTRACT

A detection system for monitoring and recording distance to at least one target. The detection system may comprise at least one module comprising: a power source; a trigger unit configured to detect the presence of the target; an enablement mechanism in communication with the trigger unit and operable to generate an enablement signal upon detection of the target; a data gathering unit comprising at least one measurement sensor operable to obtain at least one measured parameter and to record the at least one measured parameter in a memory; and a retrieval mechanism for providing access to records stored in the memory.

### CROSS-REFERENCE TO RELATED APPLICATIONS

This application claims the benefit of priority from U.S. Provisional Patent Application No. 61/858,127, filed Jul. 25, 2013, the content of which is incorporated by reference in its entirety.

### FIELD OF THE INVENTION

The disclosure herein relates to detection systems and monitoring. In particular the disclosure relates to combining passive detection with active measurement functionality for use in a detection system, enabling accurate data gathering upon sensing the proximity of a target in their vicinity with extremely low power consumption.

### BACKGROUND OF THE INVENTION

Detection and sensing systems may come in a variety of “flavors” and approaches aiming of detecting motion, presence of suspicious targets, traffic and the like, using sensing devices in different ways and used in various aspects of the modern era. Such sensing and detection may be used as security systems, temperature and pressure sensing systems, fire detection systems, alarm detection systems, gas detection systems, home security systems, surveillance systems and more.

Sensing devices may use different technologies such as infrared employing active and passive sensors; optics employing video and camera systems; radio frequency based employing radar, microwave; sound employing microphone or acoustic sensors; vibration and magnetism are additional possible technologies. Yet, all the various sensing devices consume power and are mostly passive, limited in functioning in remote places or requiring high maintenance.

There is therefore a need for low powered passive detection with active measurement functionality for use in a detection system, to enable accurate data gathering upon sensing the proximity of a target in the vicinity of the source.

### SUMMARY OF THE INVENTION

It is according to one aspect of the current disclosure to present a detection system for monitoring and recording distance to at least one target. The detection system may comprise at least one module comprising: a power source; a trigger unit configured to detect the presence of the target; an enablement mechanism in communication with the trigger unit and operable to generate an enablement signal upon detection of the target; a data gathering unit comprising at least one measurement sensor operable to obtain at least one measured parameter and to record the at least one measured parameter in a memory; and a retrieval mechanism for providing access to records stored in the memory.

It is particularly noted that the trigger unit comprises a passive detector and the measurement sensor is operable to draw power from the power source only when the enablement signal is received from the enablement mechanism.

As appropriate, the measured parameter of the detection system comprises a target distance characterized as the distance from the measurement sensor to the at least one target.

Optionally, the trigger unit of detection system may comprise a device configured to draw low power from the power source.

Variously, the trigger unit of the detection system is selected from the group consisting of: motion detectors, passive infrared sensors, accelerometers, audio sensors, microphones, pressure monitors, optical detectors and combinations thereof.

Variously, where appropriate, the data gathering unit of the detection system comprises at least one ancillary sensor selected from temperature sensors, humidity sensors, pressure sensors and combinations thereof.

Optionally, the measurement sensor of the detection system comprises a device to measure distance with an accuracy above a threshold value, for example, selected from the group consisting of: about ±15%, about ±10%, about ±7.5%, about ±5%, about ±4%, about ±2.5%, about ±2%, about ±1%, about ±0.5% or the like as appropriate.

Variously, the at least one measurement sensor of the detection system is selected from the group consisting of: an ultrasonic transducer, a laser measurement device and combinations thereof.

Where appropriate, the enablement mechanism of the detection system comprises signal enablement receiver and a signal enablement transmitter, to enable actual measurement while drawing low power from the power source.

Where required, the retrieval mechanism of the detection system comprises a wired output mechanism to allow local retrieval of recorded information.

Optionally, the detection system may further comprise a transmitter operable to communicate with an external unit. Variously, the external unit of the detection system is selected from the group consisting of a control server, a base unit, another module and combinations thereof. Variously, the transmitter of the detection system is selected from the group consisting of wireless transmitters, radio transmitters, pulse transmitters, Bluetooth enabled device transmitters, ZigBee modules, Zwave devices, EnOcean devices, INSTEON devices, DASH7 devices, WiFi devices, Near Field Communication devices, or the like and combinations thereof.

Optionally, the detection system may further comprise a network, where the network comprises a plurality of the at least one module.

Where appropriate, the memory of the detection system may be situated in a control server, where the control server may comprise a central processor.

Where appropriate, the central processor of detection system is operable to receive a plurality of target distances from the plurality of modules and estimate position of the at least one target.

Additionally or alternatively, the central processor of the detection system is operable to receive a plurality of target distances from the plurality of modules over time and estimate a path taken by the at least one target over time.

It is according to a another aspect of the disclosure to teach a method for monitoring at least one target, comprising the steps of: providing at least one module comprising a trigger sensor and a measurement sensor; detecting the presence of said at least one target with said trigger sensor; initiating an enablement signal upon the detecting the presence of said target; the measurement sensor obtaining a target distance upon receiving the enablement signal, the target distance characterized as the distance between the measurement sensor and the target; and recording the target distance in a memory.

Where appropriate, the trigger sensor comprises a device configured to draw low power from a power source.

Optionally, the trigger sensor is a passive sensor.

Variously, the trigger sensor of the detection system is selected from the group consisting of: motion detectors, passive infrared sensors, accelerometers, audio sensors, microphones, pressure monitors, optical detectors and combinations thereof.

Optionally, the measurement sensor comprises a device to measure distance with an accuracy above a threshold value, for example of about ±15%, about ±10%, about ±7.5%, about ±5%, about ±4%, about ±2.5%, about ±2%, about ±1%, about ±0.5% or the like as appropriate.

Variously, the measurement sensor is selected from the group consisting of an ultrasonic transducer, a laser measurement device and combinations thereof.

It is according to a further aspect of the disclosure to teach yet another method for monitoring at least one target, the method comprising the steps of providing a plurality of modules comprising a trigger sensor, a measurement sensor and a transmitter, detecting the presence of the at least one target with the trigger sensor of at least one of said plurality of modules; initiating an enablement signal upon the detecting the presence of the target; a measurement sensor obtaining a target distance upon receiving said enablement signal, said target distance characterized as the distance between said measurement sensor and said target; and recording said target distance in a memory.

Optionally, the memory is being situated in a control server, where the control server comprises a central processor operable to receive a plurality of target distances from the plurality of modules.

The method may further comprise a processor step of estimating the path taken by said at least one target based on said plurality of target distances over time.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram illustration of a detection module including a trigger unit, enablement mechanism and a data gathering unit for recording data of a target;

FIG. 2 is a block diagram illustration of a centrally controlled detection module combining passive detection with active measurement functionality for use in a detection system for recording data relating to a target;

FIG. 3 is a block diagram illustration of a detection module including a multi-sensor data gathering unit, providing remote access to recorded data through a communication unit;

FIG. 4 is a block diagram illustration of a detection module coupled with a sensor array for sensing presence and measuring target data for use in a detection system;

FIG. 5 is a block diagram illustration of a detection module including a detailed multi-sensor data gathering unit with combined power source functionality enabling solar charging;

FIG. 6A is a block diagram illustration of a network configuration of a detection system connectable to a central controller;

FIG. 6B is a block diagram illustration of a network configuration of a detection system with synchronization capabilities of detection modules;

FIG. 7A is a block diagram illustration of a network deployment of a detection system showing target outside “cross-talk” zones;

FIG. 7B is a block diagram illustration of a network deployment of a detection system showing target inside “cross-talk” zones;

FIG. 8A is a block diagram illustration of detection module components with communicating functionality between all sub-modules;

FIG. 8B is a schematic representation of a network deployment of a detection system showing spreadable quick deployment detection system;

FIG. 9 is a schematic representation of a detection system example used for warning drivers of animals approaching a road;

FIG. 10A is a flowchart representing possible management of a detection module combining detection and measurement functionality communicating with a remote central controller;

FIG. 10B is a flowchart representing possible management of a detection module combining detection and measurement functionality for use in a detection system for monitoring a given area;

FIG. 11 is a schematic representation of a detection module for use in a detection system for recording data relating to a target; and

FIG. 12 is a schematic representation of a shelve configuration illustrating deployment of detection modules for use in a detection system in a supermarket facility for counting targets.

### DETAILED DESCRIPTION OF THE INVENTION

Aspects of the present disclosure relate to providing a feasible solution to enable detection and monitoring of areas or facilities accurately with low power consumption. Such areas or facilities may be either crowded or protected where entry may need to be controlled, limited or prevented.

In particular the disclosure relates to combining passive detection with active measurement functionality for use in a detection system, enabling accurate data gathering upon sensing the proximity of a target in their vicinity with extremely low power consumption.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

Sensing and detecting the presence of a target may trigger measuring of various parameters related to the target such as measuring distance by using ultrasonic technology, sensing movements using 3D accelerometers, sensing presence of moving targets within its field of view using a passive infrared sensor, measuring local temperature, humidity and pressure using a dedicated sensor, monitoring activity in its vicinity using microphones or the like.

The current disclosure provides for detection functionality for monitoring and recording, operable to measure accurately a variety of parameters at low power consumption. A measured parameter, such as a target distance, characterized as the distance from a measurement sensor to a target, may provide monitoring data of crowded areas at a point in a specific facility, interest of customers in certain products help in store layout to improve shopping experience and the like.

Where appropriate, such detection functionality may be applied to counting application, security, loss prevention, animal detection, safety, smart dust and may be integrated into OEM products.

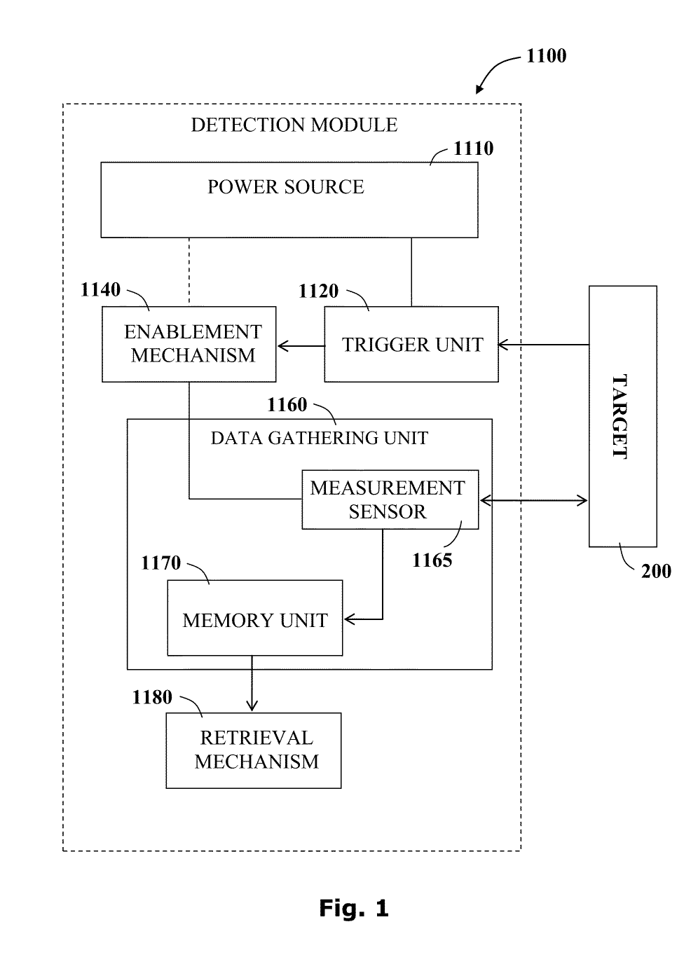

Referring to FIG. 1, a block diagram is presented illustrating selected components of a detection module 1100 for use in a detection system for recording data relating to a target 200. A detection system may comprise one or more such detection modules 1100 which are operable to measure a variety of parameters relating to the target 200 such as its distance from the module or the like. It is noted that the configuration of each detection module 100 enables accurate data gathering relating to targets in their vicinity with extremely low power consumption.

The detection module 1100 may include a power source 1110, at least one trigger unit 1120, at least one enablement mechanism 1140, a data gathering unit 1160 and a retrieval mechanism 1180.

Each detection module 1100 may use a low power trigger sensor to sense the proximity of a target in its vicinity and to trigger the enablement mechanism 1140. The enablement mechanism 1140 may then transmit an enablement signal to a higher power consuming data gathering unit 1160. Accordingly, the data gathering unit 1160 is only activated when the target is close by.

By only activating the higher power data gathering unit 1160 when a target is already known to be in the vicinity of the detection module 1100, the overall power requirements of the detection module 1100 may be very low, allowing the module to be used for long periods without being connected to any external power supply, or without requiring power cells to be regularly replaced or recharged.

The power source 1110 may include a power storage unit such as an electrochemical cell, a fuel cell or the like. Where appropriate, the power source 1110 may additionally or alternatively include a power harvesting unit such as a solar cell, a magnetic dynamo, a piezo-electric element, a wireless power receiver or the like. Optionally the power source 1110 may also include a charging circuit for controlling charging of the power storage unit, for example interfacing with a power harvesting element, regulating remote wireless or inductive charging, rectifying an AC power input from a mains connection and the like.

The trigger unit 1120 may be configured to detect the presence of the target 200 while drawing very low power from the power source 1110. For example, a low power trigger unit 1120 may be a passive device such as a passive infrared detector, a microphone, an accelerometer or the like.

The enablement mechanism 1140, which is in communication with the trigger unit 1120, is operable to generate an enablement signal when the target 200 is detected. The enablement signal is provided to activate the data gathering unit 1160 to collect parameters relating to the target 200.

It is particularly noted that, in its non-active state, the data gathering unit 1160 is normally configured not to draw any power from the power source and to wait until the enablement signal is received.

The data gathering unit 1160 may include at least one measurement sensor 1165 and at least one memory unit 1170. The measurement sensor 1165 is configured and operable to obtain at least one measured parameter and to record the at least one measured parameter in the memory unit 1170. The memory unit 1170 may include a data storage medium such as a volatile memory for storing instructions, data or the like or a non-volatile storage, for example, a magnetic hard-disk, flash-drive, optical disk, removable media or the like, for storing instructions and/or data.

The measurement sensor 1165 is operable to switch to its active state when the data gathering unit 1160 receives the enablement signal from the enabling mechanism 1140. Upon activation, the measurement sensor 1165 is configured to draw power from the power source and to start measuring and recording parameters relating to the target 200.

Various ancillary measurement sensors 1165 may be incorporated into the data gathering unit 1160 such as active distance measurement sensors such as ultrasonic transducers, laser measurement apparatus and the like. Further sensors may include accelerometers, cameras, microphones, temperature sensors, humidity sensors, pressure sensors and the like.

The retrieval mechanism 1180 may comprise a wired output mechanism and may be configured to provide access to measurement data records stored in the memory unit 1170. Measured data may be accessed locally, additionally or alternatively, where appropriate the retrieval mechanism 1180 may provide a communication channel to and/or from a remote central controller.

It is noted that, in some embodiments, the memory unit 1170 may be incorporated into the data gathering unit 1160. Alternatively, in other configurations, the memory unit 1170 may be a separate unit external to the data gathering unit 1160.

According to some embodiments and by way of illustration only, the detection module 1100 may be used for monitoring a target in a facility. The facility, such as any of shopping centers, supermarkets, museums, concert halls, exhibition centers, stadia and the like may be equipped with a plurality of networked detection modules. Such a network may allow collection of target distance parameters possibly as a function of time. The distance measurements may enable a user to monitor the movements and locations of targets within the facility, for example. Such measurements may be used to provide data reflecting interest in specific locations which may be associated with products upon shelves, exhibits in a museum, pictures in a gallery or the like. Additionally or alternatively, the detection system may be used for activating scenarios, triggering an alarm, a video, audio record or the like if target accesses prohibited areas.

The detection system may further be used to provide data for analysis of crowded areas requiring attention. Optionally, where appropriate, output data may be displayed in a variety of reports for different purposes, such as graphical ‘thermal maps’ or the like, where frequency of targets detected within different regions may be noted with different colored areas on the map for example.

Location of targets may be determined from a measured parameter of a target distance characterized as the distance from the measurement sensor of the data gathering unit 1160 to the at least one target 200. Accordingly each detection module 1100 may be equipped with a trigger sensor for triggering transmission of an enabling signal upon sensing a target in its vicinity thereby activating the measurement sensor 1165 of data gathering unit 1160, to record the distance to the target.

It is particularly noted that the measurement sensor 1165 of the data gathering unit 1160 is operable to draw power from the power source 1110, only when the enablement signal is received from the enablement mechanism 1140. Thus, because of the extremely low power consumption, the power unit 1110 may be operable for several years powered only by low storage power cells, possibly using two standard AA batteries for example.

Optionally, each networked detection module 1100 may communicate with another detection module 1100 deployed in the facility. Additionally or alternatively, each detection module 1100 in the deployment may be centrally managed via a central controller, enabling the transmission of the measured data to the central controller for further analysis.

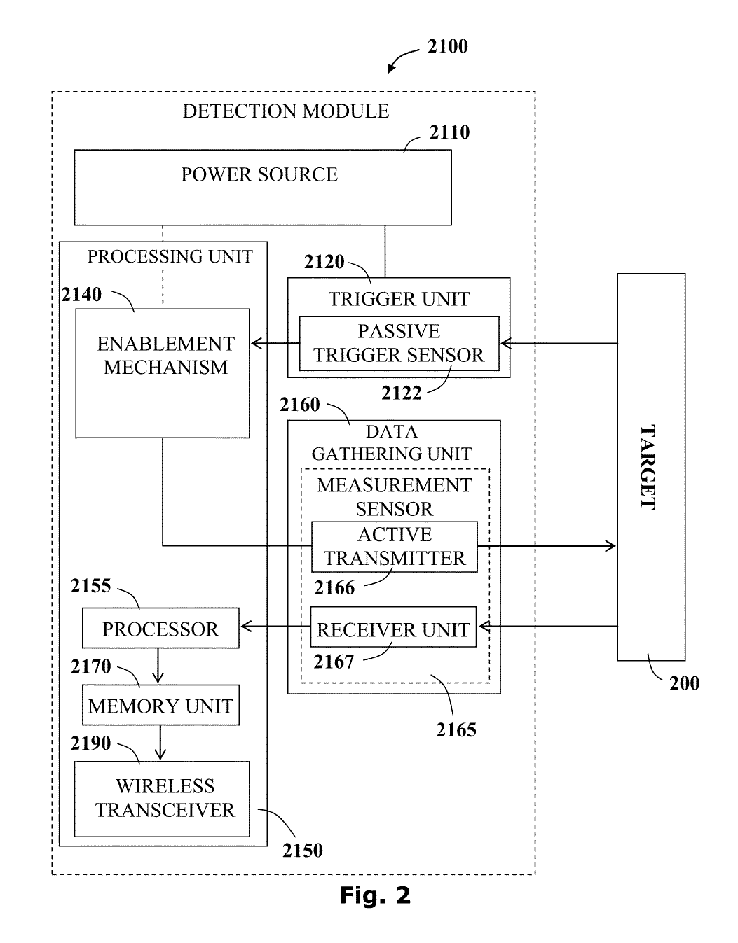

Referring to FIG. 2, a block diagram is presented illustrating selected components of a particular example of a detection module 2100 which combines passive detection with active measurement functionality for use in a detection system for recording data relating to a target 200. A detection system may comprise one or more such detection modules 2100 such that a variety of parameters relating to the target 200 such as its distance from the module or the like may be recorded.

The detection module 2100 may include a power source 2110, at least one trigger unit 2120, at least one processor 2150 and a data gathering unit 2160.

Each detection module 2100 may be equipped with a low power trigger sensor configured to function in a passive mode with a low power consumption, to sense the proximity of a target in its vicinity. The data gathering unit 2160 may be configured to respond upon receiving an enablement signal from the enablement mechanism 2140 of the processing unit 2150, to start monitoring the detected target 200 actively possibly drawing a higher power from the power source 2110.

The trigger unit 2120 may include a passive trigger sensor 2122 configured to detect the presence of the target 200 responsible for activating the measurement sensor 2165 only when needed, while drawing very low power from the power source 2110. It is noted that passive sensors 2122 may draw very little power from the power source and may instead draw power from the target itself, for example from heat generated by the target, pressure exerted by the target, sound, vibrations or other movements produced directly or indirectly by the target. Various passive trigger sensors 2122 may be incorporated into the system such as a passive infrared detector, a microphone, an accelerometer, Geiger-Muller tubes or the like.

The data gathering unit 2160 may include at least one measurement sensor 2165. The measurement sensor 2165 itself my possibly include an active transmitter 2166 and a receiver unit 2167.

The measurement sensor 2165 is operable to switch to its non-active state when the active transmitter 2166 receives the enablement signal from the enabling mechanism 2140. Upon activation, the active transmitter 2166 may be configured to draw power from the power source 2110 and to transmit a probing signal towards the target 200, and the receiver unit 2167 may be operable to receive echoes, reflections or other signals indicating measurement parameters relating to the target. For example the intensity and direction of a reflected signal may be detected by the receiver unit 2167 indicating target distance and target direction from which the target's location may be determined.

Various active transmitters 2166 may be incorporated into such a data gathering unit, such as ultrasonic transducers, lasers, chemical probes, and the like.

Accordingly, the measurement sensor 2165 is configured and operable to obtain at least one measured parameter when the active transmitter 2166 is receiving an enabling signal from the enablement mechanism 2140, indicating to start monitoring the detected target 200 and to record the at least one measured parameter received through the receiver unit 2167 in the memory unit 2170 incorporated in the processing unit 2150.

The processing unit 2150 may include an enablement mechanism 2140, a processor 2155, a memory unit 2170 and a wireless transceiver 2190. Such a processing unit 2150, or various combinations of elements of a processor, may be incorporated into a single chip, or one or more printed circuit boards (PCBs) as required.

The memory unit 2170 may include a data storage medium such as a volatile memory for storing instructions, data or the like or a non-volatile storage, for example, a magnetic hard-disk, flash-drive, optical disk, removable media or the like, for storing instructions and/or data. Variously, the memory unit 2170 may be incorporated into the processing unit 2150. Alternatively, in other configurations, the memory unit 2170 may be a separate unit external to the processing unit 2150.

The processing unit 2150 may be configured to trigger the measuring cycle by transmitting an enabling signal from its enablement mechanism 2140 to the measurement sensor 2165, and further operable to receive measurement data for storage in its memory unit 2170. The processing unit 2150 may further be configured to perform initial analysis, upon receiving measurement data or may store data and postpone the analysis processing to be executed upon external requests received through the wireless transceiver 2190.

The wireless transceiver 2190 may be configured to provide a communication channel between the processing unit and an external processor for allowing access to measurement data records stored in the memory unit 2170. Measured data may be accessed locally, additionally or alternatively, where appropriate the wireless transceiver 2190 may provide access to a remote central controller.

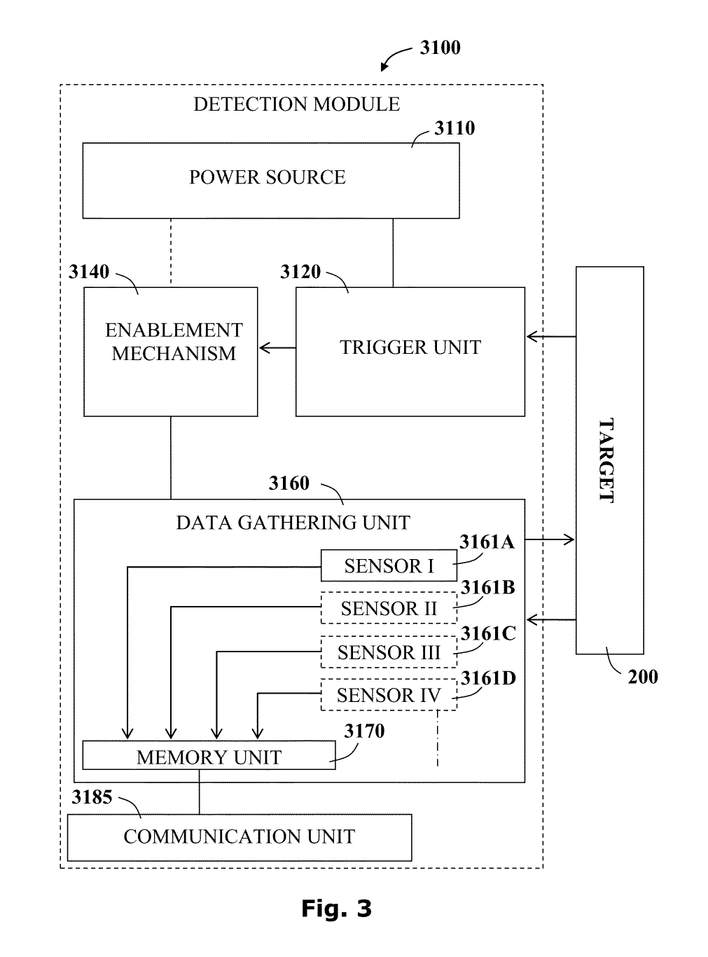

Referring now to the block diagram of FIG. 3, another embodiment is presented to illustrate selected components of another detection module 3100 for use in a detection system for recording data relating to a target 200 and providing remote access to recorded data through a communication unit 3185. The detection system may comprise one or more such detection modules 3100 operable to measure a variety of parameters relating to the target 200 such as the target's distance from the module, its direction or the like, and possibly other environmental parameters such as temperature, humidity and the like using extremely low power.

The detection module 3100 may include a power source 3110, at least one trigger unit 3120, at least one enablement mechanism 3140, a data gathering unit 3160 and a communication unit 3185.

Each detection module 3100 may be equipped with a low power trigger sensor for triggering the enablement mechanism 3140 to transmit an enablement signal, upon sensing the proximity of a target in its vicinity. Accordingly, the data gathering unit 3160 may be activated only when the target is close by.

It is particularly noted that collected measurement data may depend upon the type of sensors incorporated. Ultrasonic sensors may be used to measure distance to target, 3D Accelerometers for sensing movement such as fence vibrations, microphones to monitor activity in its vicinity, passive infrared sensor to sense the presence of moving targets within the field of view, or the like.

The power source 3110 may include a power storage unit such as an electrochemical cell, a fuel cell or the like. Where appropriate, the power source 3110 may additionally or alternatively include a power harvesting unit such as a solar cell, a magnetic dynamo, a piezo-electric element or the like.

The trigger unit 3120 may be configured to detect the presence of the target 200, while drawing very low power from the power source 3110. For example, a low power trigger unit 3120 may be a passive device such as a passive infrared detector, a microphone, an accelerometer or the like.

The data gathering unit 3160 may include at least one measurement sensor of the possible set of 3161A-3161 D of different types or a combination thereto and a memory unit 3170.

The data gathering unit 3160 may be configured and operable to obtain at least one measured parameter when any of the sensors 3161A-D receives the enabling signal from the enablement mechanism 3140. The incorporated sensors 3161A-D is illustrated by way of example and depend on measurements requirements. If only a specific measurement is required such as distance to a target, only a single ultrasonic distance sensor may be used. Additionally or alternatively, a temperature sensor may be used to monitor temperature, a microphone to monitor activity in the vicinity, humidity sensor for measuring level of humidity and the like.

The enablement mechanism 3140, which is in communication with the trigger unit 3120, is operable to generate an enablement signal upon detection of the target 200. The enablement signal is provided to activate the data gathering unit 3160 to collect parameters relating to the target 200.

Variously, all sensors 3161A-D may be activated together to initiate the gathering of multiple parameters simultaneously. Alternatively, a sensing sequence may be initiated whereby a first measurement sensor is activated and the activation of subsequent sensors may be dependent upon the target-parameters measured by the first measurement sensor.

For example, a detection module may initially detect a target via a passive trigger sensor, such as a passive IR detector, for example. This may enable the data gathering unit to first activate an active ultrasound detector, say to record the location of the target. Then, if the location is within a certain region, say, a third measurement sensor may be activated to gather more data, for example a video camera may be activated to record the target, or a temperature sensor may be activated to record temperature or the like. Accordingly the system is activated to start monitoring the detected target 200 and to record the at least one measured parameter received through the sensors 3161A-D or a combination thereof in the memory unit 3170 incorporated in the data gathering unit 3160.

The communication unit 3185 may be configured to provide access to measurement data records stored in the memory unit 3170, enabling communication of the measured data to a central controller for processing the data using advanced algorithms, integrating received data into a joint database to provide further analysis capabilities, presentation functionality, setting alarms or the like.

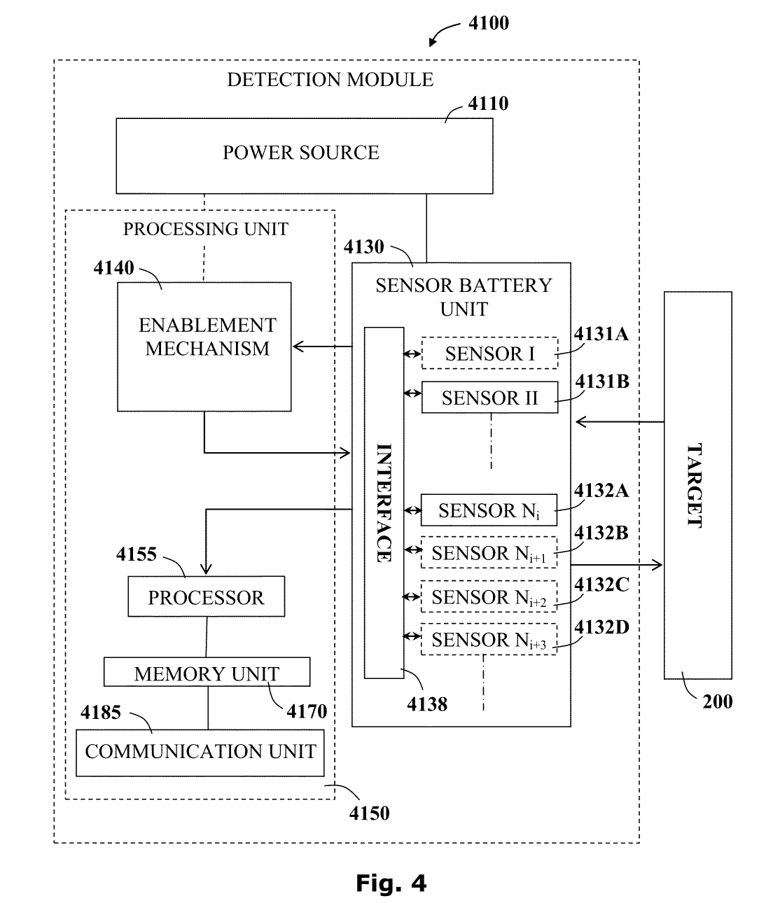

Referring now to the block diagram of FIG. 4, another embodiment is presented to illustrate selected components of another detection module 4100 coupled with a sensor array for use in a detection system, for recording data relating to a target 200 and providing remote access to recorded data through a communication unit 4185. The detection system may comprise one or more such detection modules 4100 operable to measure a variety of parameters relating to the target 200 such as its distance from the module, its direction or the like, using extremely low power.

The detection module 4100 may include a power source 4110, a sensor battery unit 4130 and a processing unit 4150.

Each detection module 4100 may be equipped with a sensor battery unit 4130 including two types of sensor arrays: a low power consumption sensor array for sensing the proximity of a target 200 and a measurement sensor array for measuring distance, movement, vibrations, temperature, humidity or the like.

The power source 4110 may include a power storage unit such as an electrochemical cell, a fuel cell or the like. Where appropriate, the power source 4110 may additionally or alternatively include a power harvesting unit such as a solar cell, a magnetic dynamo, a piezo-electric element or the like.

The sensor battery unit 4130 may include a triggering sensor array 4131A, 4131B (collectively 4131), a data measuring sensor array 4132A-D (collectively 4132), with at least one incorporated sensor in any of the two arrays and an interface 4138.

It is particularly noted that in its non-active state, the sensor battery unit 4130 is normally configured not to draw any power from the power source until the enablement signal is received.

The sensor battery unit 4130 may be configured to detect the presence of the target 200, while drawing very low power from the power source 4110 and may further be configured and operable to obtain at least one measured parameter when the enabling signal is received through the interface 4138.

At least one of the incorporated triggering sensor array 4131 may be configured for triggering the enablement mechanism 4140 to transmit an enabling signal, upon sensing the proximity of a target in its vicinity, transmitting an indication to the enablement mechanism 4140.

At least one of the incorporated data measuring sensor array 4132 may be configured and operable to receive at least one measurement data record for storage in its memory unit 4170. The memory unit 4170 may include a data storage medium such as a volatile memory for storing instructions, data or the like or a non-volatile storage, for example, a magnetic hard-disk, flash-drive, optical disk, removable media or the like, for storing instructions and/or data.

It is particularly noted that the nature of collected measurement data depends on type of sensors 4131, 4132 incorporated in the sensor battery unit 4130. Ultrasonic sensors may be used to measure distance to target, 3D Accelerometers for sensing movement such as fence vibrations, microphones to monitor activity in its vicinity, passive infrared sensor to sense the presence of moving targets within the field of view, or the like.

The interface 4138 is configured and operable to switch to a non-active state when receiving the enablement signal from the enabling mechanism 4140, upon activation, the interface 4138 is configured to start measuring and recording parameters relating to the target 200.

The processing unit 4150 may include an enablement mechanism 4140, a processor 4155, a memory unit 4170 and a communication unit 4190. Such a processing unit 4150, or various combinations of elements of a processor, may be incorporated into a single chip, or one or more printed circuit boards (PCBs) as required.

The processing unit 4150 may be configured to trigger the measuring cycle by transmitting an enabling signal from its enablement mechanism 4140 to the measurement sensor battery unit 4130, and further operable to receive measurement data for storage in its memory unit 4170. The processing unit 4150 may further be configured to perform initial analysis, upon receiving measurement data or may store data and postpone the analysis processing to be executed upon external requests received through the communication unit 4190.

The memory unit 4170 may include a data storage medium such as a volatile memory for storing instructions, data or the like or a non-volatile storage, for example, a magnetic hard-disk, flash-drive, optical disk, removable media or the like, for storing instructions and/or data. Variously, the memory unit 4170 may be incorporated into the processing unit 4150. Alternatively, in other configurations, the memory unit 4170 may be a separate unit external to the processing unit 4150.

The enablement mechanism 4140, which is in communication with the sensor battery unit 4130 through its interface 4138, is operable to generate an enablement signal upon detection of the target 200. The enablement signal is provided to activate any of the sensors of the data measuring sensor array 4132 to collect parameters relating to the target 200.

Variously, all sensors 4132 may be activated together to initiate the gathering of multiple parameters simultaneously. Alternatively, a sensing sequence may be initiated whereby a first measurement sensor is activated and the activation of subsequent sensors may be dependent upon the target-parameters measured by the first measurement sensor.

The communication unit 4185 may be configured to provide access to measurement data records stored in the memory unit 4170, enabling to communicate the measured data to a central controller for processing the data using advanced algorithms, integrating all received data into a joint database to provide further analysis capabilities, presentation functionality, setting alarms or the like.

It is noted that the communicating unit 4185 may include a wired output mechanism, such as USB cables or the like, where appropriate, configured to provide access to measurement data records stored in the memory unit 4170 locally.

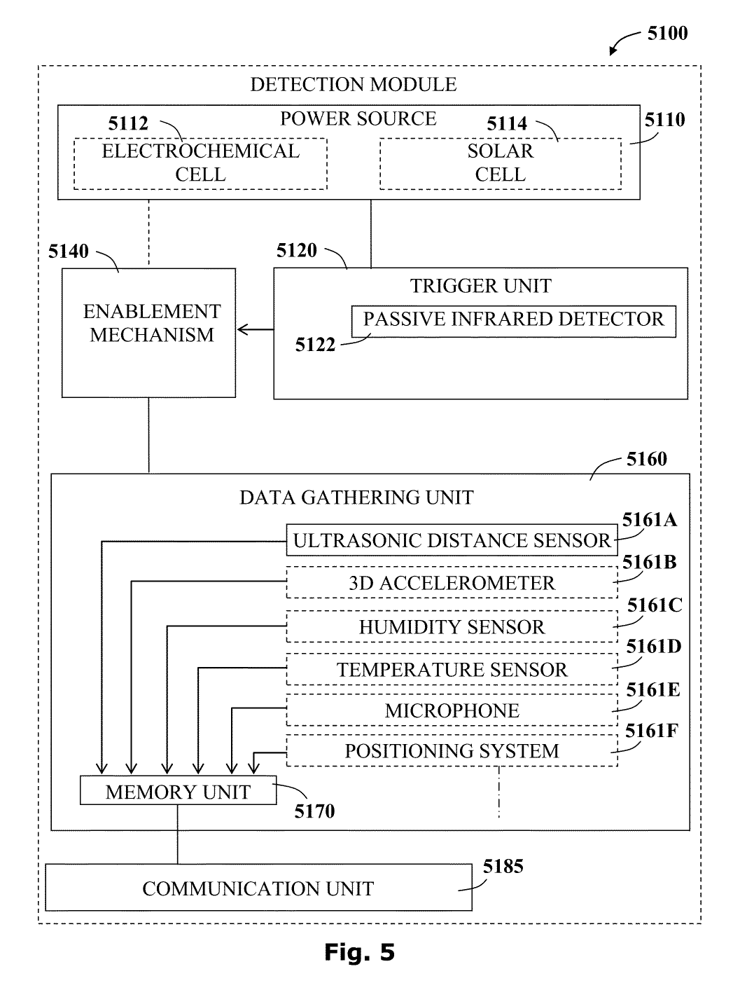

Referring now to block diagram of FIG. 5, a particular embodiment is presented to better illustrate selected components of another detection module 5100 for use in a detection system for recording data relating to a target 200 (not shown) providing a possible configuration of a power source 5110 and a possible sensor arrangement of a data gathering unit 5160. The detection system may comprise one or more such detection modules 5100 operable to measure a variety of parameters relating to the target 200 (not shown) such as its distance from the module, its direction or the like, using extremely low power.

The detection module 5100 may include a power source 5110, at least one trigger unit 5120, at least one enablement mechanism 5140, a data gathering unit 5160 and a communication unit 5185.

Each detection module 5100 may be equipped with a low power trigger sensor for triggering the enablement mechanism 5140 to transmit an enablement signal, upon sensing the proximity of a target in its vicinity. Accordingly, the data gathering unit 5160 may be activated only upon receiving the enabling signal, indicating the target is close by.

It is particularly noted that collected measurement data may depend upon the type of sensors incorporated into the data gathering unit 5160. Ultrasonic sensors may be used to measure distance to target, 3D Accelerometers for sensing movement such as fence vibrations, microphones to monitor activity in its vicinity, passive infrared sensor to sense the presence of moving targets within the field of view, or the like.

The power source 5110 may include a power storage unit such as an electrochemical cell 5112, a power harvesting unit such as a solar cell 5114 or a combination thereof, possibly with recharging functionality. Where appropriate, the power source 5110 may additionally or alternatively include a power harvesting unit such as a magnetic dynamo, a piezo-electric element, a fuel cell or the like as well as charging circuitry as required such as a regulator, a rectification unit such as a diode bridge, smoothing capacitors and the like.

The trigger unit 5120 may include a passive trigger sensor 5122 configured to detect the presence of the target 200 (not shown) responsible for activating the any of the measurement sensors 5161A-F only when needed, of a combination thereto, while drawing very low power from the power source 5110. It is noted that passive infrared detector 5122 may draw very little power from the power source and may instead draw power from the target itself, for example from heat generated by the target, pressure exerted by the target, sound, vibrations or other movements produced directly or indirectly by the target. Various passive trigger sensors 2122 may be incorporated into the system such as a passive infrared detector, a microphone, an accelerometer, Geiger-Muller tubes or the like.

The data gathering unit 5160 may include at least one measurement sensor of the possible type such as an ultrasonic distance sensor 5161A, a 3D accelerometer 5161B, Humidity sensor 5161C, a temperature sensor 5161D, a microphone 5161E and a positioning system 5161F or a combination thereto, and a memory unit 5170.

It is noted that the list of sensors presented is by way of example, illustrating the different possibilities and combinations thereto and is not limiting in any way.

The data gathering unit 5160 may be configured and operable to obtain at least one measured parameter when any of the sensors 5161A-F receives the enabling signal from the enablement mechanism 5140. The incorporated sensors 5161A-F is illustrated by way of example and depend on measurements requirements. If only a specific measurement is required, such as distance to a target, only a single ultrasonic distance sensor may be used. Additionally or alternatively, a temperature sensor may be used to monitor temperature, a microphone to monitor activity in the vicinity, humidity sensor for measuring level of humidity and the like.

The enablement mechanism 5140, which is in communication with the trigger unit 5120, is operable to generate an enablement signal upon detection of the target 200 (not shown). The enablement signal is provided to activate the data gathering unit 5160 to collect parameters relating to the target 200 (not shown).

Variously, all sensors 5161A-F may be activated together to initiate the gathering of multiple parameters simultaneously. Alternatively, a sensing sequence may be initiated whereby a first measurement sensor is activated and the activation of subsequent sensors may be dependent upon the target-parameters measured by the first measurement sensor.

The communication unit 5185 may be configured to provide access to measurement data records stored in the memory unit 5170, enabling to communicate the measured data to a central controller for processing the data using advanced algorithms, integrating all received data into a joint database to provide further analysis capabilities, presentation functionality, setting alarms or the like.

It is noted that the communicating unit 5185 may include a wired output mechanism, such as USB cables or the like, where appropriate, configured to provide access to measurement data records stored in the memory unit 5170 locally.

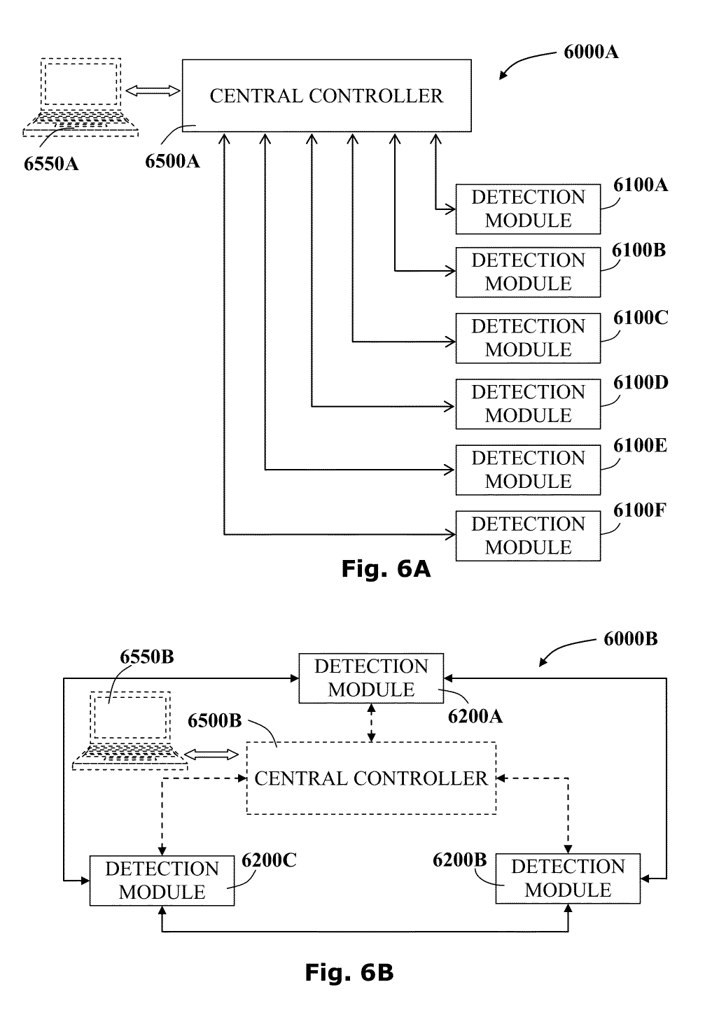

FIG. 6A and FIG. 6B represent possible network deployments using central controller or configured to synchronize adjacent detection modules, enabling different scenarios and illustrating possible settings of the detection system network deployment.

The detection system may form a connectable variant of a network to provide connectivity, enable data transfer, synchronization between detection modules used in different scenarios answering different needs, depending on the type of incorporated measurement sensors within the detection module components.

Referring now to the block diagram of FIG. 6A, a network configuration is presented to illustrate deployment of selected detection modules 6100A-F for use in a detection system 6000A for recording data relating to a plurality of targets 200 (not shown).

The detection system 6000A includes one or more detection modules 6100A-F, a central controller 6500A and optionally a connectable digital display device 6550A such as a display screen, a laptop computer or the like, possibly with remote access through a communication network.

The detection modules 6100A-F are operable to measure a variety of parameters relating to the target 200 (not shown) such as its distance from the module, its direction, temperature, humidity, pressure, vibrations or the like, using extremely low power.

Where appropriate, the measured data may be communicated to a central controller 6500A updating a central repository. Additionally or alternatively he measured data may be communicated to the other detection modules for synchronization purposes through the central controller 6500A.

It is noted that the deployment of detection modules 6100A-F is illustrated by way of example only and the number of participant detection module depends on the actual desired deployment.

The detection system 6000A may include a central controller 6500A, a plurality of detection modules 6100A-F and optionally a display screen 6550A.

Each detection module 6100A-F may be equipped with a communication module connectable to the central controller 6500A and configured to allow one-way or a two-way communication.

If one way communication is configured, possible functionality may allow the detection modules to communicate collected data measurements to the central controller 6500A, adding new records to the central repository for further analysis and/or presentation, building an integrated data repository of data measurements. Optionally, it may further allow remote configuration of the detection modules to change settings according to a planned schedule, for example.

If two-way communication is configured, then possible functionality may allow control of the central controller 6500A over every detection module, including what and assessment when and what to measure, synchronizing, updating the central repository with additional analyzed data or the like.

Referring now to block diagram of FIG. 6B, a network configuration is presented to illustrate deployment of selected detection module 6200A-C for use in a detection system 6000B for recording data relating to a plurality of targets 200 (not shown).

The detection system 6000B may include one or more detection modules 6200A-C, a central controller 6500B and optionally, a connectable digital display device 6550B such as a display screen, a laptop computer or the like, possibly with remote access through a communication network.

The detection modules 6200A-C (collectively 6200) are operable to measure a variety of parameters relating to the target 200 (not shown) such as its distance from the module, its direction, temperature, humidity, pressure, vibrations or the like, using extremely low power.

Where appropriate, the measured data may be communicated to a central controller 6500A updating a central repository. Additionally or alternatively the measured data may be communicated to the other detection modules for synchronization purposes.

It is noted that the deployment of three detection modules 6200 is presented for ease of illustration only. It will be appreciated that such an interconnected network may include any number of intercommunicating detection modules 6200 as required.

Optionally, the detection system 6000B may further include a central controller 6500B, a plurality of detection modules 6200 and optionally a display screen 6550B.

Each detection module 6200 may be equipped with a communication module connectable to all other detection units of the deployment. Optionally, each detection module may be further connectable with the central controller 6500B and configured to allow one-way or a two-way communication to all communication appliances of the deployment.

If one way communication is configured, possible functionality may allow the detection modules to communicate collected data measurements to the central controller 6500A, adding new records to the central repository for further analysis and/or presentation, building an integrated data repository of data measurements. Optionally, it may further allow to remote configuration of the detection modules to change settings according to a planned schedule, for example.

If two-way communication is configured, then possible functionality may allow the central controller 6500B to control detection modules where appropriate, for example determining what and assessment when and what to measure, synchronizing, updating the central repository with additional analyzed data or the like.

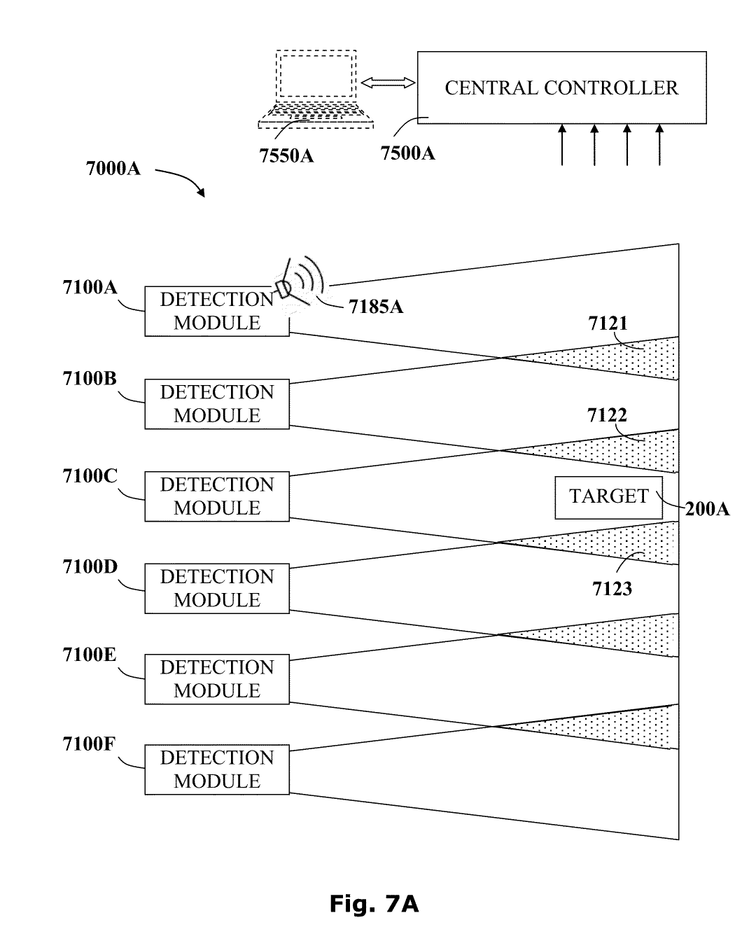

FIG. 7A and FIG. 7B represent network deployments, illustrating possible “cross-talk” zones representing an overlapping detection field of two adjacent detection modules.

A target located in a “cross-talk” zone may result in a duplicate identification by two or more different detection modules, creating a possible problem where unique identification is of importance.

Where appropriate, a duplicate identification may be resolved either by using advanced algorithms upon storing measuring data on the central controller repository or by using synchronization messages between adjacent detection modules, for example.

It is particularly noted that cross-talk elimination mechanisms may be provided to eliminate any potential “cross-talk” between detection modules.

Referring now to block diagram of FIG. 7A, a network configuration is presented to illustrate deployment of selected detection module 7100A-F for use in a detection system 7000A for recording data relating to a plurality of targets (only one sample target 200A is shown).

The detection system 7000A includes one or more detection modules 7100A-F, a central controller 7500A, optionally a display monitor 7550A and a communication unit 7185A.

Additionally, possible “crosstalk” zones are indicated, such as zone 7121, resulting from an overlapping detection field of two adjacent detection modules, 7100A and detection module 7100B.

In the scenario illustrated in FIG. 7A, target 200A is identified and measured only by detection module 7100C as it is clearly out of any possible “crosstalk” zones, such as 7122 (defined by detection modules 7100B and 7100C) or 7123 (defined by detection modules 7100C and 7100D).

The communication unit 7185A, of detection module 7100A is serving for communication purposes, to transmit the measured data records to the remote central controller 7500A, or to transmit synchronization messages to adjacent detection modules.

It is noted that a single communication unit 7185A (of detection unit 7100A) is shown, for ease of illustration only.

Referring now to block diagram of FIG. 7B, a network configuration is presented to illustrate deployment of selected detection module 7200A-F for use in a detection system 7000A for recording data relating to a plurality of targets (only one sample target 200A is shown).

The detection system 7000B includes one or more detection modules 7200A-F, a central controller 7500B, optionally a display monitor 7550B and communication units 7185C and 7185D (only two communication units are shown by way of example, for ease of illustration).

Additionally, possible “crosstalk” zones are indicated, such as zone 7221, resulting from an overlapping detection field of two adjacent detection modules, 7200A and detection module 7200B or zone 7222, resulting from an overlapping detection field of two adjacent detection modules, 7200B and detection module 7200C.

In the current scenario, target 200B resides within the “crosstalk” zone 7223 and is identified and measured by two detection modules, 7200C and 7200D.

All communication units may be configured to transmit all data measurements of its detection module to the remote central controller 7500B for adding the measured records to the joint repository and may further be configured to remove duplicate records of identical targets of different detection modules.

Additionally or alternatively, the communication unit 7185C of detection unit 7200C, by way of example, may be configured to synchronize with its adjacent communication unit 7185D of detection unit 7200D, and drop any duplicated records before transmission of measured data to the central controller 7500B.

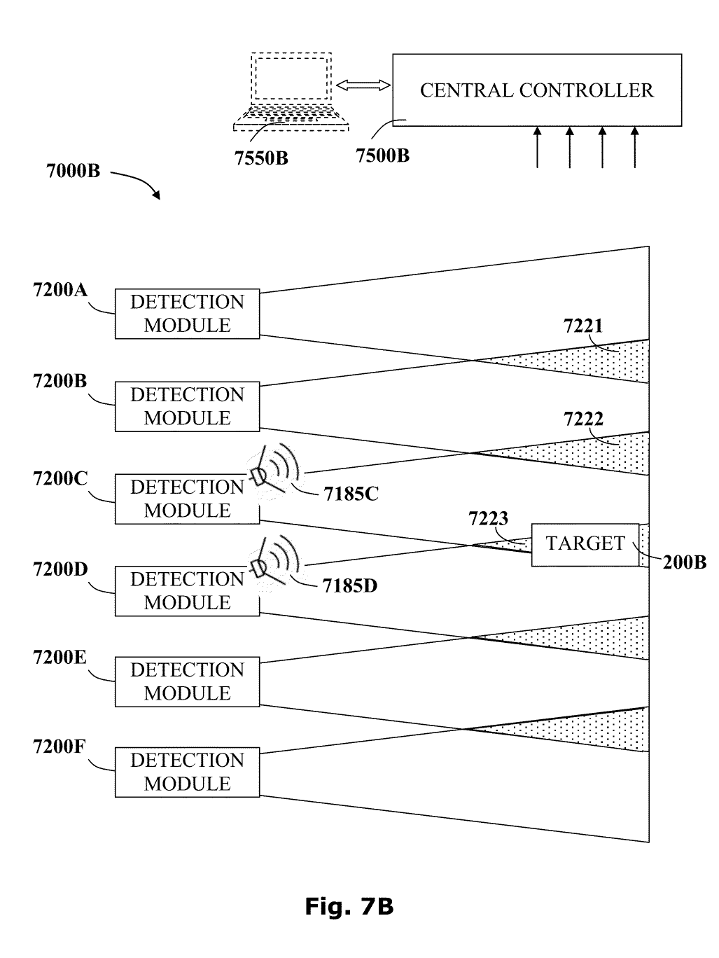

Referring to FIG. 8A, a block diagram is presented illustrating selected components of a networked detection module 8100A for use in a detection system with data measurement and recording functionality. A detection system may comprise a plurality of such detection modules 8100A which are operable to measure a variety of parameters in various deployments, such as monitoring a given area.

The detection module 8100A may include a power source 8110, at least one trigger unit 8120, at least one enablement mechanism 8140, a data gathering unit 8160 and a communication unit 8180.

Each detection module 8100A may use a low power trigger sensor configured to detect the presence of a target and to trigger the enablement mechanism 8140. The enablement mechanism 8140 may then transmit an enablement signal and activate a higher power consuming data gathering unit 8160 to collect parameters relating to the detected target. Accordingly, the data gathering unit 8160 is only activated when the target is close by. Optionally, each networked detection module 8100A may communicate with another detection module 8100A deployed in the monitored area through a communication unit 8180. Additionally or alternatively, each detection module 8100A in the deployment may be centrally managed via an optional central controller (not shown), enabling the transmission of the measured data to the central controller for further analysis.

It is noted that multiple detection module 8100A units may communicate with one another through radio network to enable data transfer and synchronization.

It is further noted that a memory unit (not shown) may be incorporated as part of the detection module 8000 and a processing unit (not shown) may further be incorporated to allow local computation and analysis.

Referring now to block diagram of FIG. 8B, a network configuration is presented to illustrate a deployment of detection system 8000.

A deployment of a detection system 8000, such as spreadable quick deployment detection system, may include one or more detection modules 8100B for recording data relating to monitoring a given area.

The detection module 8100B may include a power source 8110 (FIG. 8A), at least one trigger unit 8120 (FIG. 8A), at least one enablement mechanism 8140 (FIG. 8A), a data gathering unit 8160 (FIG. 8A) and a communication unit 8180 (FIG. 8A).

The trigger unit 8120 (FIG. 8A) may include a passive trigger sensor configured to detect the presence of a target (not shown) for triggering the enablement mechanism 8140 (FIG. 8A) to transmit an enablement signal for activating any of the measurement sensors incorporated in the data gathering unit 8160 (FIG. 8A), when needed.

Each detection module 8100B may be configured to synchronize measured data and any other monitoring information with adjacent detection modules. Optionally, each detection module may store the measured data in a memory unit (not shown) and further communicate the stored measured data to a central controller (not shown) which may be configured to process the combined measured data, integrating it into one joint database. Optionally, alerting when appropriate.

It is particularly noted that the nature of monitoring of the given area may depend upon the type of sensors incorporated into the data gathering unit 8160 (FIG. 8A). Ultrasonic sensors may be used to measure distance to target, 3D Accelerometers for sensing movement such as fence vibrations, microphones to monitor activity in its vicinity, passive infrared sensor to sense the presence of moving targets within the field of view, a dedicated sensor for measuring local temperature and humidity or the like.

Such a spreadable quick deployment detection system 8000 may be used for example by emergency services to readily and rapidly assess and monitor a target zone. Additionally or alternatively, other spreadable detection systems 8000 may be used in military applications for example for providing battlefield intelligence harvesting in real time.

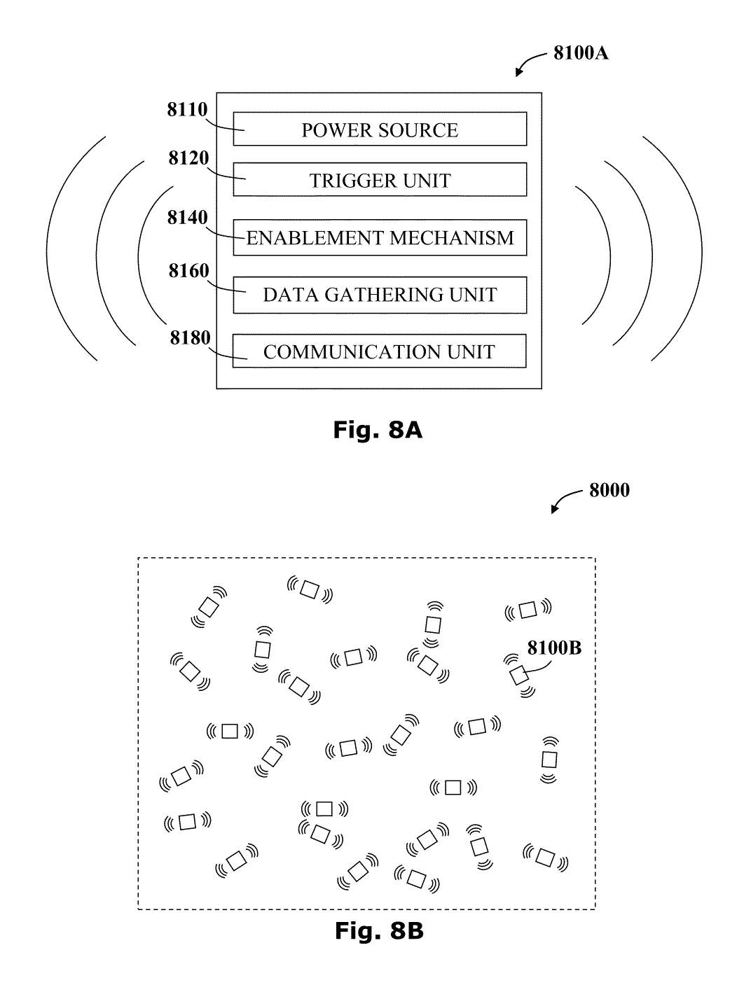

Referring to FIG. 9, a block diagram representation is presented of a detection system deployment 9000 for providing an early warning system for drivers. In remote areas or other areas where wild animals may wander onto a road and which are often badly lit, wild animals present a common hazard. The detection system deployment 9000 may be deployed along a road 9200 by installing at least one warning sign 9300 where animals 300 may approach the road unaware of the traffic.

The detection system deployment 9000 may include one or more detection modules 9100, where each detection module includes a power source 9110A and a communicating unit (not shown).

The power source 9110A may include a power storage unit such as an electrochemical cell, a fuel cell or the like. The detection module 9100A may additionally or alternatively include a power source 9110A with a power harvesting unit such as a solar cell appropriate for isolated sceneries with appropriate climate.

The detection system deployment 9000 may include one or more detection modules 9100 connectable directly to one or more warning sign 9300, configured to light the warning message upon receiving an indication signal from the communication unit (not shown) of the detection module 9100, upon sensing the presence of an animal 3000 in its vicinity.

Optionally, each detection module 9100 of the detection system deployment 9000 may be connected to a remote central controller (not shown), communicating at least one measured data record received when an animal 300 is detected and measuring of distance starts. Upon receiving the at least one measured data record on the remote central controller, processing may start and initiate a warning signal to drivers by turning on the warning post 9300, when required.

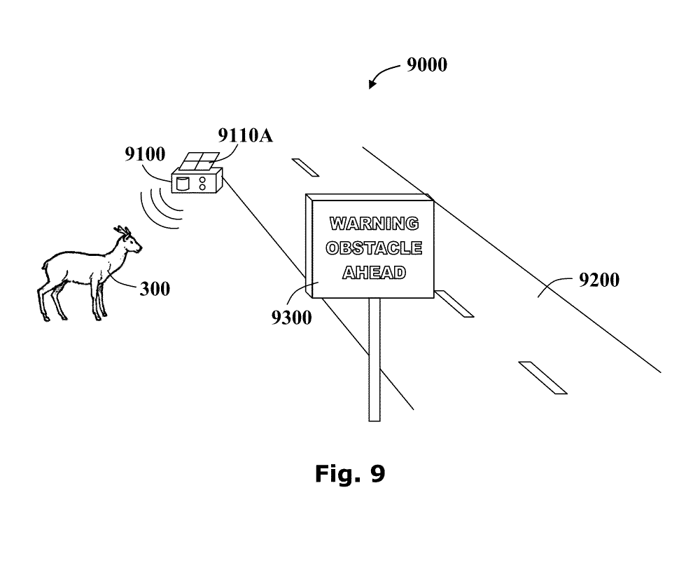

Referring to the flowchart of FIG. 10A, a method is disclosed for managing a detection module which combines passive detection and measurement functionality for use in a detection system to record data relating to a target, interacting with a central controller.

The method includes the steps: providing a module comprising a triggering sensor and a measurement sensor units, the module is configured to transmit at least one measured data record to a remote central controller and activated upon receiving an enabling signal from an associated enabling mechanism 1002A; sensing the presence of at least one target by the triggering sensor 1004A; initiating an enabling signal upon detection the presence of a target 1006A; and transmitting the signal to the enabling mechanism, activating the measuring sensor; obtaining, at least one measurement data record containing distance to the target from the measuring sensor 1008A; storing the received at least one measurement data record in an associated memory unit 1010A; and transmitting the at least one measurement data record of distance from target to a central controller for data base integration 1012A, enabling further analysis such as creating ‘thermal map’ representing crowded areas or the like.

Referring to the flowchart of FIG. 10B, a method is disclosed for managing a detection module which combines detection and measurement functionality for use in a detection system for monitoring a given area, synchronizing adjacent detection modules.

The method includes the steps: providing a plurality of detection modules, each module comprising a triggering sensor unit and a measurement sensor unit, the module is configured to synchronize at least one measured data record with adjacent detection modules of a networked deployed detection system 1002B; sensing the presence of at least one target by the triggering sensor 1004B; initiating an enabling signal upon detection the presence of a target 1006B; and transmitting the signal to the enabling mechanism, activating the measuring sensor; obtaining, at least one measurement data record containing measurements such as distance, temperature, humidity and the like from the measuring sensor 1008B; storing the received at least one measurement data record in an associated memory unit 1010B; and transmitting a message containing the at least one measurement data record to adjacent detection module 1012A, enabling further monitoring analysis. Optionally, the at least one measurement data record may be transmitted to a central controller.

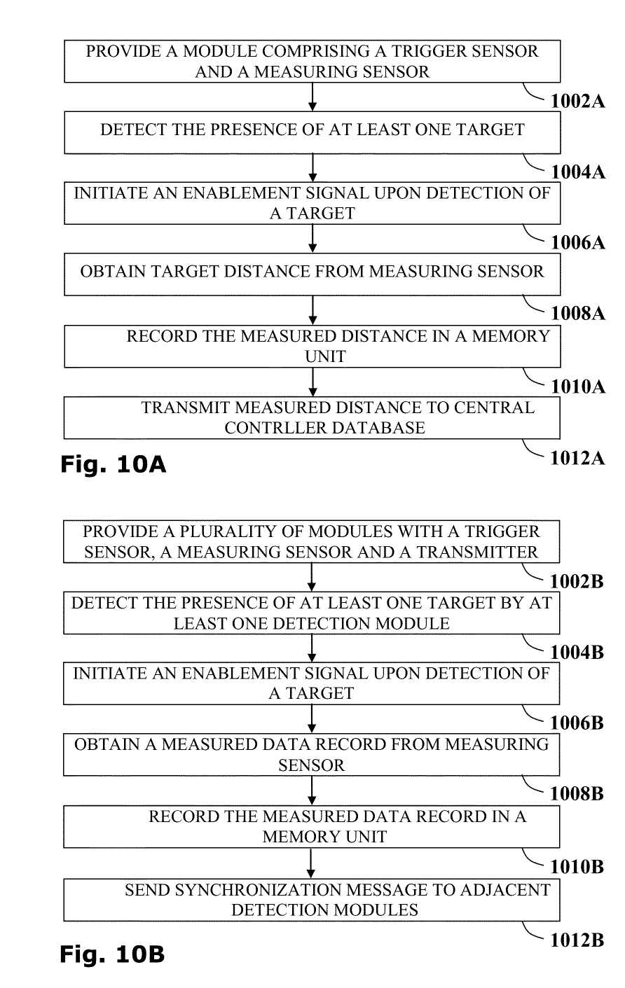

Referring to FIG. 11, a block diagram is presented illustrating selected components of a detection module 1400 for use in a detection system for recording data relating to a target (not shown).

The detection module 1400 may include a unit box 1402 encapsulating a passive infrared sensor 1404, an active transmitter 1406, a receiver unit 1408, and functional indicators 1410, 1412.

The passive infrared sensor 1404 is operable to switch to its non-active state when the active transmitter 1406 receives the enablement signal from the enabling mechanism (not shown). Upon activation, the active transmitter 1406 may be configured to draw power from the power source (not shown) and to transmit a probing signal towards the target (not shown), and the receiver unit 1408 may be operable to receive echoes, reflections or other signals indicating measurement parameters relating to the target. For example the intensity and direction of a reflected signal may be detected by the receiver unit 1408 indicating target distance and target direction from which the target's location may be determined.

Various active transmitters 1406 may be incorporated into such a data gathering unit (not shown), such as ultrasonic transducers, lasers, chemical probes, and the like.

The detection module 1400 may be deployed in variety of facilities, answering different needs such as monitoring a distribution of a crowd in a facility at a point, measure distance to a target in its vicinity, measure any activity in its vicinity using microphones or other dedicated sensors and the like.

Optionally, the detection module 1400 may include networking capabilities and the module may be equipped with an RF radio for communicating the measured data to a central server which may process the measured data and integrate all received data into one central database. Additionally or alternatively, the detection module may provide synchronization capabilities between different units in different locations.

Functional indicators 1410, 1412, may be provided to indicate various functionality statuses such as power on, trigger detection in progress, standby mode, power low, measurement in progress, data availability signals, and the like. Indicators may be visual indicators, such as LEDs, screens, lights and the like, audio indicators such as buzzers, speakers and the like or other indicators as suit requirements.

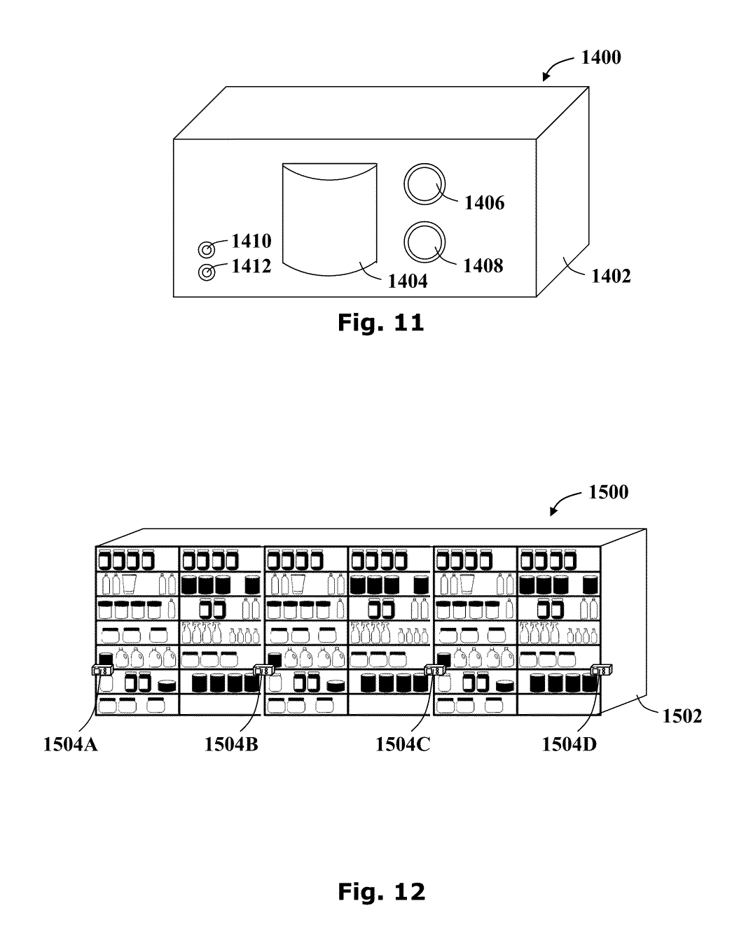

Referring now to the block diagram of FIG. 12 is showing a deployment of a detection system 1500 with detection modules 1504A-D for use in a facility.

The detection system 1500 may be deployed in a supermarket facility, for example, with a shelve configuration equipped with three detection modules for counting purposes of targets (customers—not shown) at specific product shelves or monitoring the distribution of a crowd in a facility, at a point for further analysis.

The detection system 1500 may include shelve cabinet 1502 configured with three detection modules 1504A-D.

Optionally, each detection module 1504A-D may include networking capabilities and the module may be equipped with an RF radio for communicating the measured data to a central server which may process the measured data and integrate all received data into one central database. Additionally or alternatively, the detection module may provide synchronization capabilities between different units in different locations.

Further embodiments relate to geometrical mapping for representing physical environment characteristics and activity:

A system consists of sensors array made of non-video sensors (nodes) to sense the environment and to map the geometrical space and the activity within that space.

The nodes are extremely low power, battery operated modules which read the environment using multi-technology sensing systems, such as ultrasonic, infrared, capacity change, temperature, light reflection and more.

Each node uses ultrasonic sensors to read its environment and wirelessly communicate its data to a server for post processing.

Each node uses other sensing technologies like passive Infrared detector, capacity detector, thermal detector or other technologies for the purpose of:
Reducing the power draw of the node by way of triggering sub-system that triggers the Ultrasonic sensor only when needed.
ultrasonic readings Improvement—by way of improving the sensitivity and reading resolution and adding more information to the ultrasonic readings

The gathered data from the sensors is being processed and the data from each node is used to build a geometrical map that represent the physical environment, this map can be used to count object in a determined space or to track moving objects in a defined area.

Optionally, sensing nodes may be configured to overlap.

Still further embodiments relate to extraction feature using non-video sensors:

A system consists of sensors array made of non-video sensors (nodes) to sense the environment and to map the geometrical space and the activity within that space.

Each node uses ultrasonic sensors to read its environment and wirelessly communicate its data to post processing.

Each ultrasonic reading contains the following parameters:
Distance of targets (by calculating the travel time of the US waves).
Reflectivity of the target.
Ultrasonic scatter and phase change.

The distributed system can identify each target, by activating algorithms the system can determine:
Location of each target, speed and acceleration.
Track of the target and connect partial tracks.
Hand shake with other systems to determine other features.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A detection system for monitoring and recording distance to at least one target, said detection system comprising at least one module comprising:
a power source;
a trigger unit configured to detect the presence of said target and operable to generate an enablement signal upon detection of said target;
a data gathering unit comprising at least one measurement sensor operable to obtain at least one measured parameter and to record said at least one measured parameter in a memory; and
a retrieval mechanism for providing access to records stored in said memory;
wherein
said trigger unit comprises a passive detector and said measurement sensor is operable to draw power from said power source only when the enablement signal is received from said trigger unit.

2. The detection system of claim 1 wherein said measured parameter comprises a target distance characterized as the distance from said measurement sensor to said at least one target.

3. The detection system of claim 1 wherein said trigger unit comprises a device configured to draw low power from said power source.

4. The detection system of claim 1 wherein said trigger unit is selected from the group consisting of: motion detectors, passive infrared sensors, accelerometers, audio sensors, microphones, pressure monitors, optical detectors and combinations thereof.

5. The detection system of claim 1 wherein said data gathering unit comprises at least one ancillary sensor selected from temperature sensors, humidity sensors, pressure sensors and combinations thereof.

6. The detection system of claim 1 wherein said measurement sensor comprises a device to measure distance with an accuracy above a threshold value.

7. The detection system of claim 1 wherein said at least one measurement sensor is selected from the group consisting of: an ultrasonic transducer, a laser measurement device and combinations thereof.

8. The detection system of claim 1 wherein said enablement mechanism comprises signal enablement receiver and a signal enablement transmitter.

9. The detection system of claim 1 wherein said retrieval mechanism comprises a wired output mechanism.

10. The detection system of claim 1 further comprising a transmitter operable to communicate with an external unit.

11. The detection system of claim 10, wherein said external unit is selected from the group consisting of a control server, a base unit, another module and combinations thereof.

12. The detection system of claim 10, wherein said transmitter is selected from the group consisting of wireless transmitters, radio transmitters, pulse transmitters, Bluetooth enabled device transmitters ZigBee modules, Zwave devices, EnOcean devices, INSTEON devices, DASH7 devices, WiFi devices, Near Field Communication devices, and combinations thereof.

13. The detection system of claim 10, further comprising a network, said network comprising a plurality of said at least one module.

14. The detection system of claim 10, said memory being situated in a control server, wherein said control server comprises a central processor.

15. The detection system of claim 14, wherein said central processor is operable to receive a plurality of target distances from the plurality of modules and estimate position of said at least one target.

16. The detection system of claim 14, wherein said central processor is operable to receive a plurality of target distances from the plurality of modules over time and estimate a path taken by said at least one target over time.

17. A method for monitoring at least one target, said method comprising the steps of:
providing at least one module comprising a trigger sensor and a measurement sensor,
detecting the presence of said at least one target with said trigger sensor;
initiating an enablement signal upon the detecting the presence of said target;
said measurement sensor obtaining a target distance upon receiving said enablement signal, said target distance characterized as the distance between said measurement sensor and said target; and
recording said target distance in a memory.

18. The method of claim 17 wherein said trigger sensor comprises a device configured to draw low power from a power source.

19. The method of claim 17, wherein said trigger sensor is a passive sensor.

20. The detection system of claim 19 wherein said trigger sensor is selected from the group consisting of: motion detectors, passive infrared sensors, accelerometers, audio sensors, microphones, pressure monitors, optical detectors and combinations thereof.

21. The method of claim 17 wherein said measurement sensor comprises a device to measure distance with an accuracy above a threshold value.

22. The method of claim 17 wherein said measurement sensor is selected from the group consisting of: an ultrasonic transducer, a laser measurement device and combinations thereof.

23. A method for monitoring to at least one target, said method comprising the steps of:
providing a plurality of modules comprising a trigger sensor, a measurement sensor and a transmitter,
detecting the presence of said at least one target with the trigger sensor of at least one of said plurality of modules;
initiating an enablement signal upon the detecting the presence of said target;
a measurement sensor obtaining a target distance upon receiving said enablement signal, said target distance characterized as the distance between said measurement sensor and said target; and
recording said target distance in a memory.

24. The method of claim 23, said memory being situated in a control server, wherein said control server comprises a central processor operable to receive a plurality of target distances from the plurality of modules.

25. The method of claim 24, wherein said method further comprises the step of the processor estimating the path taken by said at least one target based on said plurality of target distances over time.
